(19) United States
(12) Patent Application Publication
(10) Pub. No.: US 2008/0266167 A1
(43) Pub. Date: Oct. 30, 2008

(54) Object Recognition System for a Motor Vehicle

(75) Inventors: Karl-Heinz Baumann, Bondorf (DE); Michael Fehring, Neuhausen (DE); Rainer Justen, Altdorf (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/579,421

(22) PCT Filed: Apr. 23, 2005
(86) PCT No.: PCT/EP05/04380

§ 371 Date: Jun. 24, 2008

(30) Foreign Application Priority Data
May 3, 2004 (DE) 10 2004 021 561.8

(51) Int. Cl. G01S 17/93; G01S 13/93

(52) U.S. Cl. 342/52

(57) ABSTRACT

An object recognition system for a motor vehicle, including at least two object recognition sensors whose recognition ranges partly overlap in the direction of travel, is provided. The system includes a first object recognition sensor with a predetermined first vertical recognition angle concomitantly detects an object and a roadway surface in its recognition range, a second object recognition sensor with a predetermined second vertical recognition angle, which is less than the first vertical recognition angle of the first object recognition sensor, which does not concomitantly detect the roadway surface in the direction of travel in the recognition range of the first object recognition sensor, and an evaluation unit configured to determine the presence of an object in the recognition range of the first object recognition sensor only when both object recognition sensors have recognized the object.

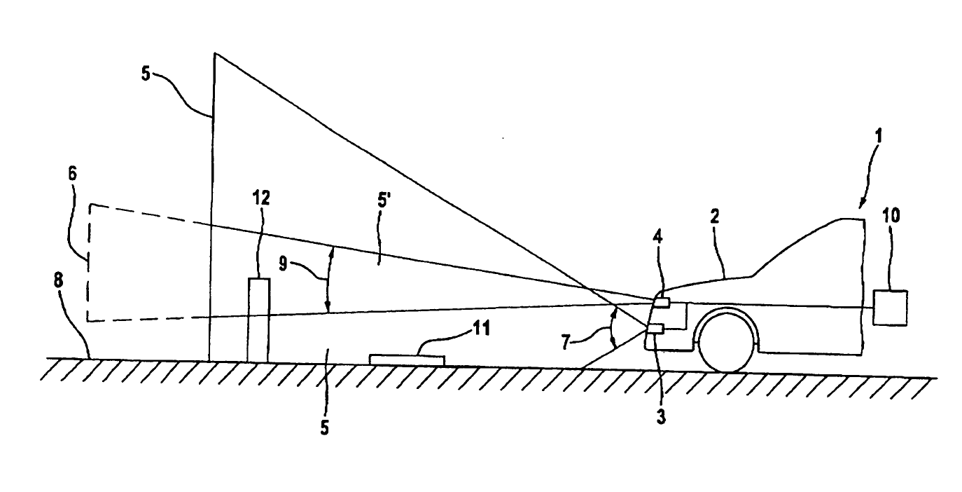

### CROSS REFERENCE TO RELATED APPLICATIONS

This application is a national stage of PCT International Application No. PCT/EP2005/004380, filed Apr. 23, 2005, which claims priority under 35 U.S.C. § 119 to German Patent Application No. 10 2004 021 561.8 filed May 3, 2004.

### BACKGROUND AND SUMMARY OF THE INVENTION

The present invention relates to an object recognition system for a motor vehicle including at least two object recognition sensors.

German patent document DE 199 34 670 A1 discloses an object detection system for a motor vehicle including a combination of at least three object detectors. The object detectors each have a different detection region and/or a different detection range. The detection regions may critically lie in front of the motor vehicle in the direction of travel and may overlap. By using a plurality of object detectors, it is possible to use the object detector that is optimally suitable for each individual detection region.

German patent document DE 195 01 612 A1 describes a method for measuring the distance between a motor vehicle and an object, which takes account of the output signals of a first measuring device with a corresponding measurement range in the case of a small object distance and the output signals of a second measuring device with a correspondingly larger measurement range in the case of a larger object distance. The first or the second measuring device is activated depending on the distance of the object from the vehicle. Moreover, the output signals of the measuring devices are weighted depending on the distance of the object from the vehicle. The two measuring devices can be operated with different physical measurement principles.

The present invention provides an object recognition system for a motor vehicle, including at least two object recognition sensors, which enables objects which actually disturb and/or impair the travel of the motor vehicle to be recognized more reliably than the object recognition systems known from the prior art.

According to the present invention, the first object recognition sensor with a predetermined first vertical recognition angle detects both an object and the roadway surface, within its recognition range. The second object recognition sensor with a predetermined second vertical recognition angle, which is less than the first vertical recognition angle of the first object recognition sensor, does not also detect the roadway surface in the direction of travel in the recognition range of the first object recognition sensor. An evaluation unit is provided, which determines the presence of an object in the recognition range of the first object recognition sensor only when both object recognition sensors have recognized the object. The object recognition system for a motor vehicle includes at least the two object recognition sensors whose recognition ranges partly overlap in the direction of travel.

With the object recognition systems known from the prior art, generally it is possible to determine the distance and the lateral position relative to the motor vehicle, whereas the height of the detected object cannot be detected. In a real traffic environment, however, objects occur which have only a small height and which the motor vehicle can travel over without the slightest difficulty. These objects include, for example, projecting manhole covers, base plates or shaft gratings. These are recognized as relevant collision objects in the case of the object recognition systems known from the prior art and lead to instances of incorrect triggering in the case of corresponding precrash systems.

The object recognition system according to the invention increases the triggering reliability for critical actuators. The use of the second object recognition sensor with the predetermined second vertical recognition angle, which is less than the first vertical recognition angle of the first object recognition sensor, enables objects which would disturb and/or impair the travel of the motor vehicle to be recognized reliably. The aim is not to recognize as many triggering scenarios as possible, but rather to suppress all unnecessary and nonrelevant triggering events. In this case, it is advantageous if the first and second object recognition sensors have different physical measurement principles. The use of two different physical measurement principles additionally increases the triggering reliability and hence the accuracy of the object recognition system.

In one exemplary embodiment of the invention, a first horizontal recognition angle of the first object recognition sensor in the direction of travel is greater than a second horizontal recognition angle of the second object recognition sensor. The evaluation unit determines the presence of an object in the recognition range of the first object recognition sensor only when both object recognition sensors have recognized the object. As a result, only those objects which actually also constitute an obstacle to the motor vehicle and manifest a real hazard potential are identified as an obstacle in the front lateral ambient regions of the motor vehicle. Undesired instances of incorrect triggering of safety devices of the motor vehicle are avoided.

Other objects, advantages and novel features of the present invention will become apparent from the following detailed description of the invention when considered in conjunction with the accompanying drawings.

### BRIEF DESCRIPTION OF THE DRAWING FIGURES

The FIGURE illustrates a schematic of a motor vehicle with an integrated object recognition system on a roadway in a side view.

### DETAILED DESCRIPTION OF THE DRAWINGS

An object recognition system 1 for a motor vehicle 2 in accordance with the FIGURE includes two object recognition sensors 3, 4 whose recognition ranges 5, 6 overlap in the region 5′ in the direction of travel. A first object recognition sensor 3 with a predetermined first vertical recognition angle 7 concomitantly detects an object and a roadway surface 8 in its recognition range 5 in the direction of travel. A second object recognition sensor 4 with a predetermined second vertical recognition angle 9, which is less than the first vertical recognition angle 7 of the first object recognition sensor 3, does not concomitantly detect the roadway surface 8 in the direction of travel in the recognition range 5 of the first object recognition sensor 3. An evaluation unit 10 determines the presence of an object 11, 12 in the recognition range 5 of the first object recognition sensor 3 only when both the first object recognition sensor 3 and the second recognition sensor 4 have recognized the object 11, 12.

In this exemplary embodiment, the flat object 11 on the roadway surface 8 is not determined to be a hazard for the motor vehicle 2, since it is detected only by the first object recognition sensor 3 and not by the second object recognition sensor 4. Since the flat object 11 would not disturb driving, no safety measures for preventive occupant protection are activated or initiated for the flat object 11.

The larger and above all higher object 12 is detected both by the first object recognition sensor 3 and by the second object recognition sensor 4 simultaneously. The higher object 12 is therefore regarded as a hazard potential for driving and safety measures for preventive occupant protection are activated and/or initiated.

The object recognition system 1 thus distinguishes between objects 12 which constitute a hazard for driving and those objects 11 which are not a hazard for driving. Therefore, instances of incorrect triggering for the activation of safety measures for preventive occupant protection can be avoided, whereby safety for the occupants of the motor vehicle is significantly increased.

The recognition of the object 11, 12 in the recognition region 5 of the first object recognition sensor 3 may also be effected when the object 11, 12 is effected by the second object recognition sensor 4, by tracking and an advance calculation of a trajectory of the object 11, 12 in the recognition region 5 of the first object recognition sensor 3.

In addition, a first horizontal recognition angle of the first object recognition sensor 3 in the direction of travel may be greater than a second horizontal recognition angle of the second object recognition sensor 4. The evaluation unit 10 determines the presence of an object 11, 12 in the recognition region 5 of the first object recognition sensor 3 only when both object recognition sensors 3, 4 have recognized the object 11, 12 simultaneously. As a result, only those objects 11, 12 which would interfere with the expected route of the motor vehicle 2 laterally in the zone ahead are recognized as hazards.

The first object recognition sensor 3 may be, for example, a radar sensor having an operating frequency of approximately 22 GHz or 24 GHz, a Light Detection and Ranging (LIDAR) sensor or a camera, where the camera may have various suitable configurations.

The second object recognition sensor may be, in particular, an Adaptive Cruise Control (ACC) radar sensor or a LIDAR sensor which uses radio-frequency microwave radiation in a frequency range of approximately 76 to 77 GHz. It is advantageous if the first and second object recognition sensors 3, 4 have different physical measurement principles.

The object recognition system 1 may also be used for at least one lateral ambient region and/or for a rear ambient region of the motor vehicle 2.

The object recognition system 1 according to the invention for the motor vehicle 2 including the two object recognition sensors 3, 4 ensures a reliable recognition of objects 12 which may be hazardous to the travel of the motor vehicle 2. Instances of incorrect triggering of safety measures for preventive occupant protection on account of detected objects 11 which are not hazardous to the motor vehicle are avoided. The object recognition system 1 can be realized with only little outlay since essential components of the object recognition system 1 are generally already provided in the motor vehicle 2 for a different application.

1-6. (canceled)

7. An object recognition system for a motor vehicle, comprising:
a first object recognition sensor, having a predetermined first vertical recognition angle, which first object recognition sensor detects both an object and a roadway surface in a first recognition range;
a second object recognition sensor, having a second recognition range and a predetermined second vertical recognition angle which is less than the first vertical recognition angle, which second object recognition sensor detects only the object in the direction of travel in the first recognition range; and
an evaluation unit configured to determine the presence of the object in the first recognition range only when both object recognition sensors have detected the object;
wherein the first and second recognition ranges partly overlap in the direction of travel.

8. The object recognition system as claimed in claim 7, wherein a first horizontal recognition angle of the first object recognition sensor in the direction of travel is greater than a second horizontal recognition angle of the second object recognition sensor.

9. The object recognition system as claimed in claim 7, wherein the first and second object recognition sensors have different physical measurement principles.

10. The object recognition system as claimed in claim 7, wherein the first object recognition sensor is selected from the group consisting of a radar sensor, a LIDAR sensor and a camera.

11. The object recognition system as claimed in claim 7, wherein the second object recognition sensor is one of an adaptive cruise control radar sensor and a LIDAR sensor.

12. The object recognition system as claimed in claim 7, wherein the object recognition system is configured for one of a lateral ambient region and a rear ambient region of the motor vehicle.

13. The object recognition system as claimed in claim 7, wherein the object recognition system is configured for a lateral ambient region and a rear ambient region of the motor vehicle.

14. A method for object recognition for a motor vehicle, comprising:
detecting an object and a roadway surface in a first recognition range, using a first object recognition sensor, which has a predetermined first vertical recognition angle;
detecting the object, without detecting the roadway surface in the direction of travel in the first recognition range, in a second recognition range, using a second object recognition sensor, which has a predetermined second vertical recognition angle that is less than the predetermined first vertical recognition angle; and
determining the presence of the object in the first recognition range, only when both object recognition sensors have detected the object;
wherein the first and second recognition ranges partly overlap in the direction of travel.

15. The method as claimed in claim 14, wherein a first horizontal recognition angle of the first object recognition sensor in the direction of travel is greater than a second horizontal recognition angle of the second object recognition sensor.

16. The method as claimed in claim 14, wherein the first and second object recognition sensors have different physical measurement principles.

17. The method as claimed in claim 14, wherein the first object recognition sensor is selected from a group consisting of a radar sensor, a LIDAR sensor and a camera.

18. The method as claimed in claim 14, wherein the second object recognition sensor is one of an adaptive cruise control radar sensor and a LIDAR sensor.

19. The method as claimed in claim 14, wherein the object recognition system is configured for one of a lateral ambient region and a rear ambient region of the motor vehicle.

20. The method as claimed in claim 14, wherein the object recognition system is configured for a lateral ambient region and a rear ambient region of the motor vehicle.
